(19) United States
(12) Patent Application Publication
(10) Pub. No.: US 2012/0164346 A1
(43) Pub. Date: Jun. 28, 2012

(54) METHOD AND DEVICE FOR FORMING PATTERN

(76) Inventors: Ikuo Yoneda, Yokohama-Shi (JP); Tetsuro Nakasugi, Yokohama-Shi (JP)

(21) Appl. No.: 13/230,591

(22) Filed: Sep. 12, 2011

(30) Foreign Application Priority Data
Dec. 22, 2010 (JP) 2010-285727

(51) Int. Cl. B05D 3/06; B05B 5/16

(52) U.S. Cl. 427/553; 118/620; 118/641

(57) ABSTRACT

According to a method for forming a pattern in one embodiment, a first pattern is formed on a substrate, and an upper part of the first pattern is irradiated with ultraviolet rays, to enhance a liquid-repellent property to an inversion resin material. Furthermore, according to the method for forming the pattern, the inversion resin material is applied to the substrate after the irradiation of the ultraviolet rays, the first pattern is removed after the inversion resin material has been applied to form a second pattern containing the inversion resin material, and the substrate is processed using the second pattern as a mask.

### CROSS REFERENCE TO RELATED APPLICATION

This application is based upon and claims benefit of priority from the Japanese Patent Application No. 2010-285727, filed on Dec. 22, 2010, the entire contents of which are incorporated herein by reference.

### FIELD

Embodiments described herein relate generally to a method and a device for forming a pattern.

### BACKGROUND

In recent years, a nanoimprint method attracts attentions as a method for forming a fine pattern. According to the nanoimprint method, an imprinting template having a concavo-convex pattern is brought into contact with a resist applied on a base substrate, the resist is cured, and the template is removed from the resist, whereby a resist pattern is formed. Then, the base substrate is processed using the resist pattern as a mask.

In addition, according to another well-known method, after the resist pattern has been formed, an inversion resin material is applied and the resist pattern is removed to form an inverted pattern corresponding to an inverted shape of the resist pattern, and the base substrate is processed using the inverted pattern as a mask.

According to the conventional method for forming the inverted pattern, the applied inversion resin material not only fills in a concave part (space part) of the resist pattern, but also exists on an upper surface of a convex part (line part). Therefore, before the resist pattern is removed, a process to expose the upper surface of the convex part is performed by removing the inversion resin material provided on the convex part.

However, a film thickness of the inversion resin material formed on the convex part in a region having a low pattern density of the resist pattern is smaller than a film thickness of the inversion resin material formed on the convex part in a region having a high pattern density of the resist pattern, so that the convex part (line part) is partially removed in the region having the low pattern density of the resist pattern at the time of the process to expose the upper surface of the convex part, which causes the pattern to be problematically thinned. In addition, the inverted pattern fluctuates in dimension, and when such inverted pattern is used as the mask, the problem is that the base substrate cannot be processed into a desired pattern.

### BRIEF DESCRIPTION OF THE DRAWINGS

FIG. 1A is a cross-sectional view showing a step of a method for forming a pattern according to a first embodiment;

FIG. 1B is a cross-sectional view subsequent to FIG. 1A;

FIG. 1C is a cross-sectional view subsequent to FIG. 1B;

FIG. 1D is a cross-sectional view subsequent to FIG. 1C;

FIG. 2A is a cross-sectional view subsequent to FIG. 1D;

FIG. 2B is a cross-sectional view subsequent to FIG. 2A;

FIG. 2C is a cross-sectional view subsequent to FIG. 2B;

FIG. 2D is a cross-sectional view subsequent to FIG. 2C;

FIG. 3A is a cross-sectional view subsequent to FIG. 2D;

FIG. 3B is a cross-sectional view subsequent to FIG. 3A;

FIG. 3C is a cross-sectional view subsequent to FIG. 3B;

FIG. 4A is a cross-sectional view showing a step of a method for forming a pattern according to a comparative example;

FIG. 4B is a cross-sectional view subsequent to FIG. 4A;

FIG. 4C is a cross-sectional view subsequent to FIG. 4B;

FIG. 4D is a cross-sectional view subsequent to FIG. 4C;

FIG. 5A is a cross-sectional view subsequent to FIG. 4D;

FIG. 5B is a cross-sectional view subsequent to FIG. 5A;

FIG. 5C is a cross-sectional view subsequent to FIG. 5B;

FIG. 6A is a cross-sectional view showing a step of a method for forming a pattern according to a second embodiment;

FIG. 6B is a cross-sectional view subsequent to FIG. 6A;

FIG. 6C is a cross-sectional view subsequent to FIG. 6B;

FIG. 6D is a cross-sectional view subsequent to FIG. 6C;

FIG. 7A is a cross-sectional view subsequent to FIG. 6D;

FIG. 7B is a cross-sectional view subsequent to FIG. 7A;

FIG. 7C is a cross-sectional view subsequent to FIG. 7B;

FIG. 7D is a cross-sectional view subsequent to FIG. 7C; and

FIG. 8 is a schematic configuration view of a pattern forming device to execute the method for forming the pattern according to the first embodiment.

### DETAILED DESCRIPTION

According to a method for forming a pattern in one embodiment, a first pattern is formed on a substrate, and an upper part of the first pattern is irradiated with ultraviolet rays, to enhance a liquid-repellent property to an inversion resin material. Furthermore, according to the method for forming the pattern, the inversion resin material is applied to the substrate after the irradiation of the ultraviolet rays, the first pattern is removed after the inversion resin material has been applied to form a second pattern containing the inversion resin material, and the substrate is processed using the second pattern as a mask.

Hereafter, embodiments of the present invention will be described with reference to the drawings.

### First Embodiment

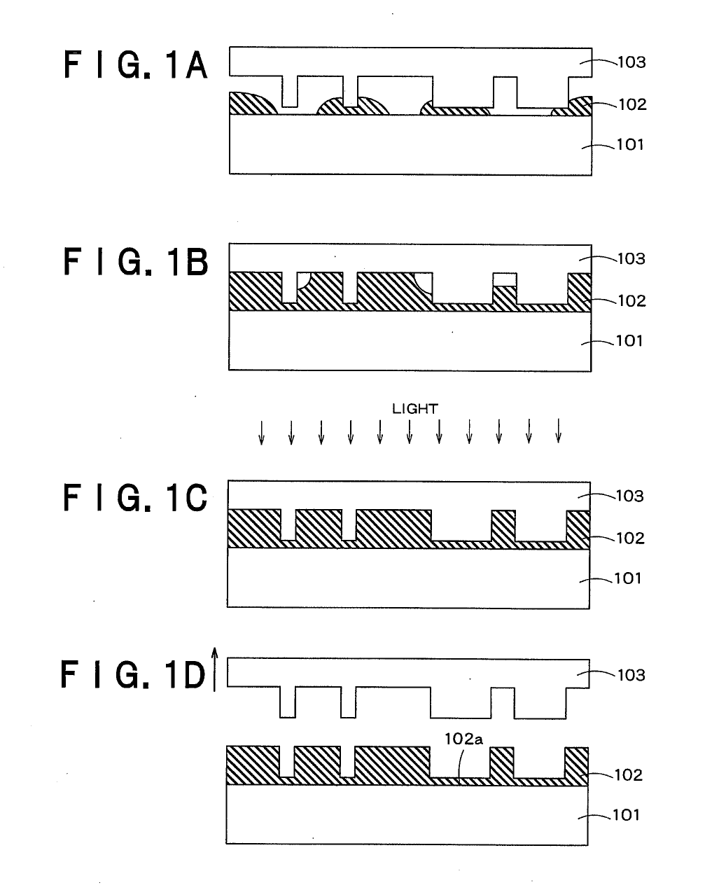

A description will be made of a method for forming a pattern according to a first embodiment of the present invention with reference to cross-sectional views of steps shown in FIGS. 1A to 3C.

As shown in FIG. 1A, a template 103 having a concavo-convex pattern is brought into contact with a liquid photo-curable organic material (imprint material) 102 applied onto a base substrate 101. The base substrate 101 may be a silicon substrate, or an insulating film such as a silicon oxide film. The template 103 is prepared such that the concavo-convex pattern is formed on a fully-transparent quartz substrate which is used in a general photomask, by plasma etching. As the photo-curable organic material 102, ultraviolet (UV)-curable SiO₂ material is used. In addition, here, it is to be noted that the base substrate 101 and the template 103 are partially shown.

After the template 103 has been brought into contact with the imprint material 102, as shown in FIG. 1B, the liquid imprint material 102 flows into the concavo-convex pattern of the template 103.

As shown in FIG. 1C, after the concavo-convex pattern has been filled with the imprint material 102, the imprint material 102 is cured by irradiation of light (UV light).

As shown in FIG. 1D, the template 103 is removed from the imprint material 102. Since the imprint material 102 has been already cured in this state, the state (shape) provided when the template 103 is in contact is maintained.

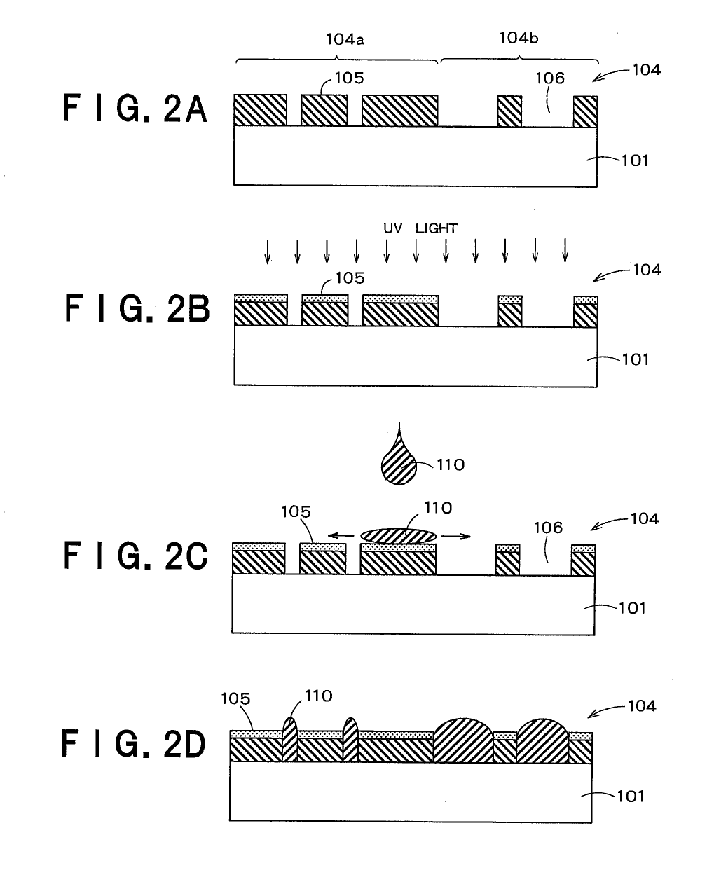

As shown in FIG. 1D, a residual film 102a exists in a part on the base substrate 101 at a part corresponding to a convex part of the template 103. Therefore, as shown in FIG. 2A, the residual film 102a is removed by a method such as reactive ion etching (RIE) using oxygen plasma, whereby a pattern serving as a mold (mold pattern) 104 is formed. The mold pattern 104 has a region 104a having a high pattern density, and a region 104b having a low pattern density. The high pattern density means that a ratio of a convex part 105 is high. In addition, the low pattern density means that a ratio of a space part (concave part) 106 is high.

As shown in FIG. 2B, UV light is vertically applied from an upper part of the mold pattern 104 toward a surface of the base substrate 101. For example, UV light having a wavelength of 193 nm is applied with an irradiation amount of 30 mJ/cm². The UV light is applied to an upper surface of the mold pattern 104 and hardly applied to a side surface thereof.

By the irradiation of the UV light, a liquid-repellent property of the surface of the mold pattern 104 to an after-mentioned inversion resin material 110 is changed. Specifically, a contact angle of the side surface of the convex part 105 of the mold pattern 104 which has been hardly irradiated with the UV light, with respect to the inversion resin material 110 is about 30°. Meanwhile, a contact angle of the upper surface of the convex part 105 of the mold pattern 104 which has been irradiated with the UV light, with respect to the inversion resin material 110 is about 80°.

After the irradiation of the UV light, as shown in FIG. 2C, the inversion resin material 110 is applied to the base substrate 101. For example, the inversion resin material 110 is dropped and subjected to spin-coating. As the inversion resin material 110, a material such as a silicon-containing resist (a silicon content is higher than that of a normal resist material) is used.

Due to the irradiation of the UV light in the step shown in FIG. 2B, the upper surface of the convex part 105 of the mold pattern 104 is high in liquid-repellent property. Therefore, as shown in FIG. 2D, a film of the inversion resin material 110 is not formed on the convex part 105, and only the space part 106 is filled with the inversion resin material 110. Then, the base substrate 101 is heated in a baking process or the like to volatilize a solvent, and cure the inversion resin material 110.

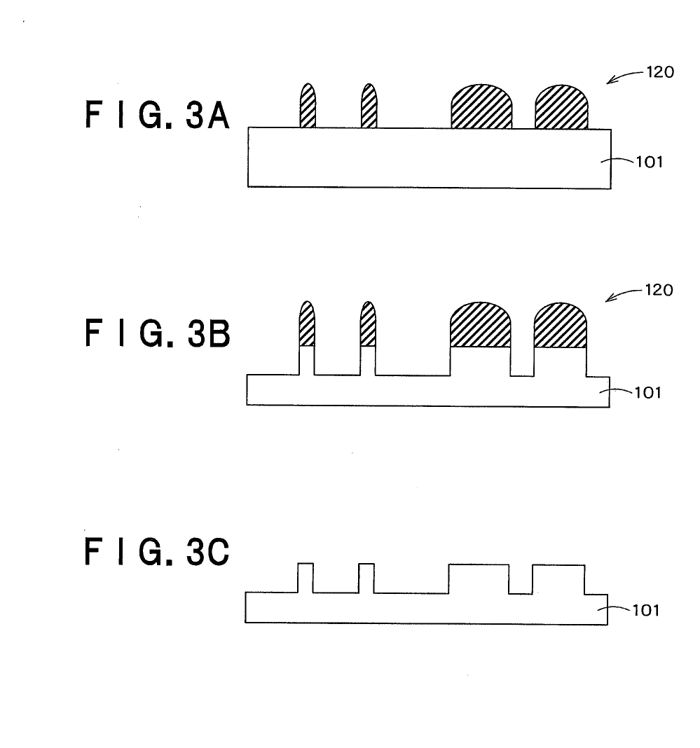

As shown in FIG. 3A, the mold pattern 104 is removed by

RIE using oxygen plasma. Thus, an inverted pattern 120 is formed such that it is composed of the inversion resin material 110 and has a pattern shape corresponding to an inverted shape of the mold pattern 104.

As shown in FIG. 3B, the base substrate 101 is processed by plasma etching or the like using the inverted pattern 120 as a mask.

Thus, after the base substrate 101 has been processed, as shown in FIG. 3C, the inverted pattern 120 is removed. To remove the inverted pattern 120, for example, a mixture gas of a silicon-containing CF series gas and oxygen is used.

Thus, according to this embodiment, since the mold pattern 104 is irradiated with the UV light to enhance the liquid-repellent property of the upper surface of the convex part 105, a film of the inversion resin material 110 is not formed on the upper surface of the convex part 105, and only the space part 106 is filled with the inversion resin material 110. Therefore, it is not necessary to perform a process to expose the upper surface of the convex part 105 of the mold pattern 104, so that the convex part 105 is not thinned. In addition, the inverted pattern 120 is prevented from fluctuating in dimension, and dimensional precision can be improved. In addition, the base substrate 101 can be processed into a desired pattern.

### COMPARATIVE EXAMPLE

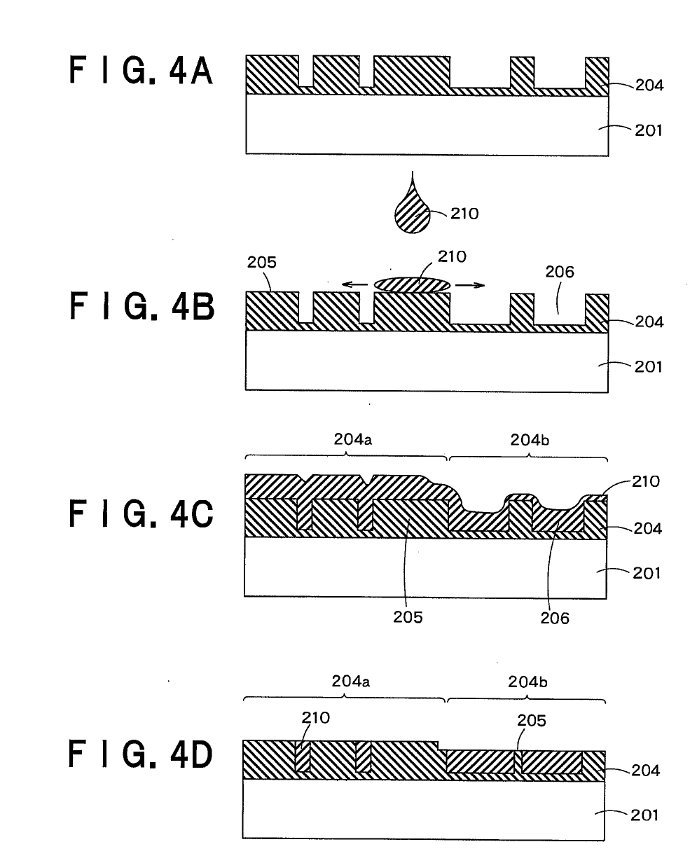

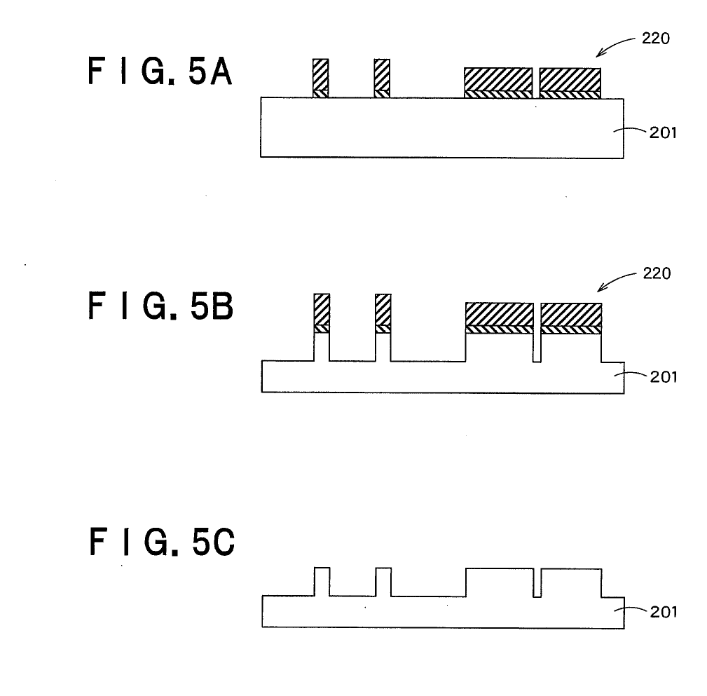

A method for forming a pattern in a comparison example will be described with reference to FIGS. 4A to 5C. As shown in FIG. 4A, a mold pattern 204 is formed on a base substrate 201. In addition, since a procedure until the mold pattern 204 is formed is the same as those of the first embodiment shown in FIGS. 1A to 1D, its description will not be repeated here. In addition, in this comparison example, a process corresponding to the removal of the residual film 102a shown in FIG. 2A is not performed.

As shown in FIG. 4B, an inversion resin material 210 is applied to the mold pattern 204. For example, the inversion resin material 210 is dropped and subjected to spin-coating. As the inversion resin material 210, a material such as a silicon-containing resist is used.

As shown in FIG. 4C, a film composed of the inversion resin material 210 is formed on a convex part 205 as well as being formed in a space part 206. At this time, the space part 206 could not been completely filled with the inversion resin material 210 in a region 204b having a low pattern density. In addition, a film thickness of the film of the inversion resin material 210 formed on the upper surface of the convex part 205 in the region 204b having the low pattern density is smaller than a film thickness of the film of the inversion resin material 210 formed on an upper surface of the convex part 205 in a region 204a having a high pattern density.

As shown in FIG. 4D, the inversion resin material 210 is removed by a method such as dry etching so that the upper surface of the convex part 205 of the mold pattern 204 is exposed. When the etching is performed until the upper surface of the convex part 205 is exposed in the region 204a having the high pattern density, as shown in FIG. 4D, the convex part 205 is partially cut and thinned in the region 204b having the low pattern density.

Then, as shown in FIG. 5A, the mold pattern 204 is removed by RIE using oxygen plasma, whereby an inverted pattern 220 is formed. Since the convex part 205 is thinned in the step shown in FIG. 4D, the inverted pattern 220 does not have a shape corresponding to an inverted shape of the mold pattern 204.

As shown in FIG. 5B, the base substrate 201 is processed by plasma etching or the like using the inverted pattern 220 as a mask. Then, after the base substrate 201 has been processed, as shown in FIG. 5C, the inverted pattern 220 is removed.

According to the method for forming the pattern in the comparative example, since a dimension fluctuates in the inverted pattern 220, the base substrate 201 cannot be processed into a desired pattern.

Meanwhile, according to the first embodiment, since the liquid-repellent property is enhanced on the upper surface of the convex part 105 because the mold pattern 104 is irradiated with the UV light, the film of the inversion resin material 110 is not formed on the upper surface of the convex part 105, and the film of the inversion resin material 110 is only formed in the space part 106. Therefore, it is not necessary to perform a process to expose the upper surface of the convex part 105 of the mold pattern 104, so that the convex part 105 is not thinned (in the region 104b having the low pattern density). In addition, the inverted pattern 120 is prevented from fluctuating in dimension, and the dimensional precision can be improved. In addition, the base substrate 101 can be processed into the desired pattern.

### Second Embodiment

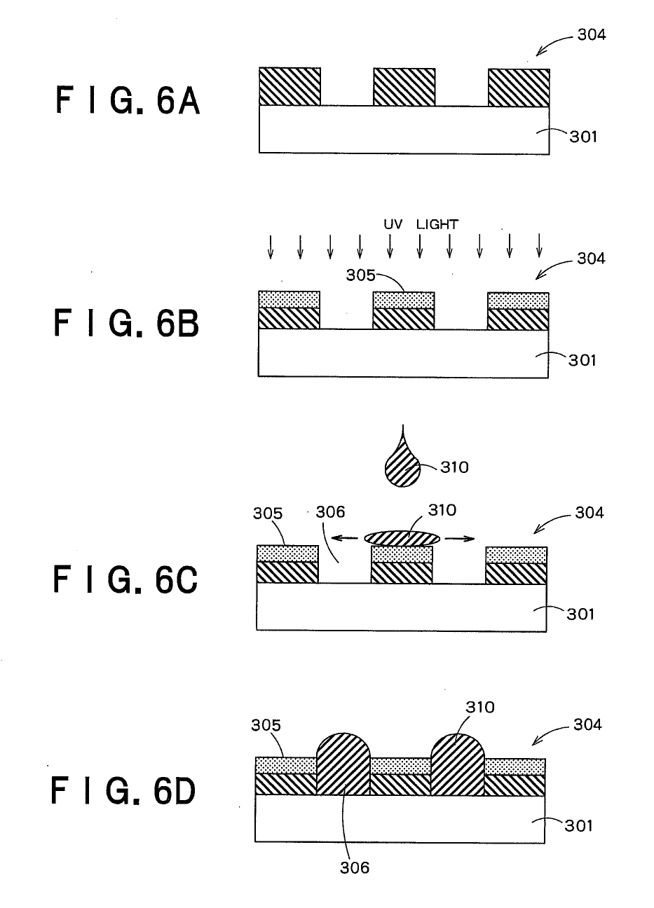

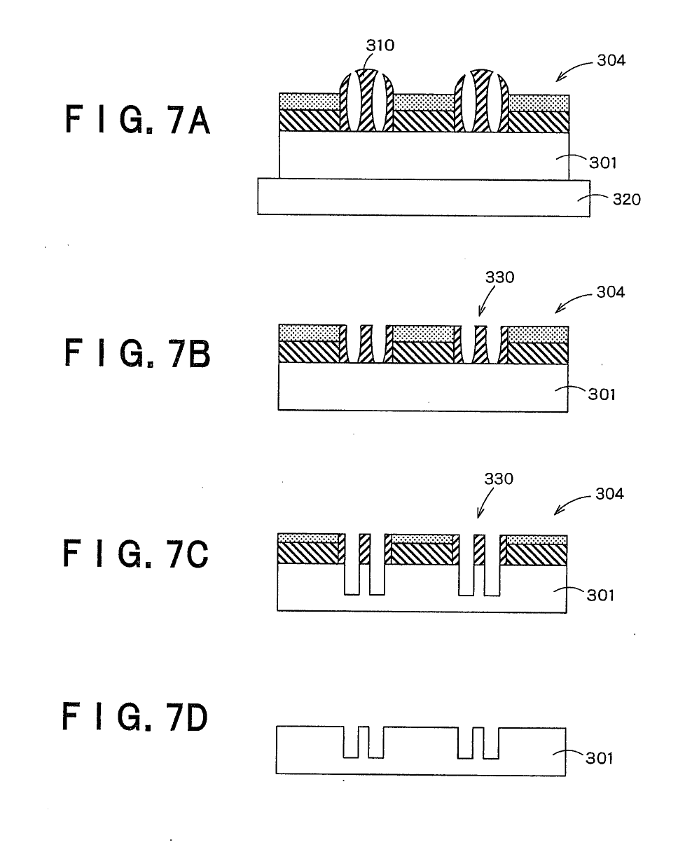

A method for forming a pattern according to a second embodiment of the present invention will be described with reference to cross-sectional views of steps shown in FIGS. 6A to 7D.

As shown in FIG. 6A, a mold pattern 304 is formed on a base substrate 301. In addition, a procedure until the mold pattern 304 is formed is the same as those in the first embodiment shown in FIGS. 1A to 1D and FIG. 2A, its description will not be repeated here.

As shown in FIG. 6B, UV light is vertically applied from an upper part of the mold pattern 304 toward a surface of the base substrate 301. For example, UV light having a wavelength of 193 nm is applied with an irradiation amount of 30 mJ/cm². An upper surface of the mold pattern 304 is irradiated with the UV light and a side surface thereof is hardly irradiated.

Due to the irradiation of the UV light, a liquid-repellent property on the surface of the mold pattern 304 to an after-mentioned self-assembled material 310 is changed. Specifically, a contact angle of the side surface of the convex part 305 of the mold pattern 304 which has been hardly irradiated with the UV light, with respect to the self-assembled material 310 is about 10°. Meanwhile, a contact angle of the upper surface of the convex part 305 of the mold pattern 304 which has been irradiated with the UV light, with respect to the self-assembled material 310 is about 30°.

After the irradiation of the UV light, as shown in FIG. 6C, the self-assembled material 310 is applied to the base substrate 301.

For example, the self-assembled material 310 is dropped and subjected to spin-coating. As the self-assembled material 310, for example, a mixture solution of polystyrene-polyethylene oxide (PS-PEO) and spin-on glass (SOG) is used.

Due to the irradiation of the UV light in the step shown in FIG. 6B, the upper surface of the concave part 305 of the mold pattern 304 is high in liquid-repellent property. Therefore, as shown in FIG. 6D, a film of the self-assembled material 310 is not formed on the upper surface of the concave part 305, and only a space part 306 is filled with the self-assembled material 310.

As shown in FIG. 7A, the base substrate 301 is heated by a baker 320, whereby phase separation is caused in the self-assembled material 310.

As shown in FIG. 7B, a top part of the self-assembled material 310 is removed by etching using fluorine series gas, whereby a phase-separated self-assembled pattern 330 is formed.

In a case where a film of the self-assembled material 310 is formed on the upper surface of the convex part 305 in the step shown in FIG. 6D, a pattern alignment of the self-assembled pattern 330 is dragged by the self-assembled material 310 formed on the upper surface of the concave part 305 at the time of the phase separation shown in FIG. 7A, and it becomes irregular and a defect is caused. However, according to this embodiment, since the liquid-repellent property is enhanced on the upper surface of the concave part 305 of the mold pattern 304, the film of the self-assembled material 310 is not formed on the upper surface of the convex part 305, so that the pattern alignment of the self-assembled pattern 330 can be regular, and the self-assembled pattern 330 can be formed with high precision.

As shown in FIG. 7C, the base substrate 301 is processed by plasma etching or the like using the mold pattern 304 and the self-assembled pattern 330 as masks.

Then, after the process of the base substrate 301, as shown in FIG. 7D, the mold pattern 304 and the self-assembled pattern 330 are removed by ashing.

Thus, according to this embodiment, the mold pattern 304 is irradiated with the UV light to enhance the liquid-repellent property on the upper surface of the concave part 305, so that a film of the self-assembled material 310 is not formed on the upper surface of the concave part 305, and the film of the self-assembled material 310 is only formed in the space part 306. Therefore, the self-assembled pattern 330 can be formed with high precision. In addition, the base substrate 301 can be processed into a desired pattern.

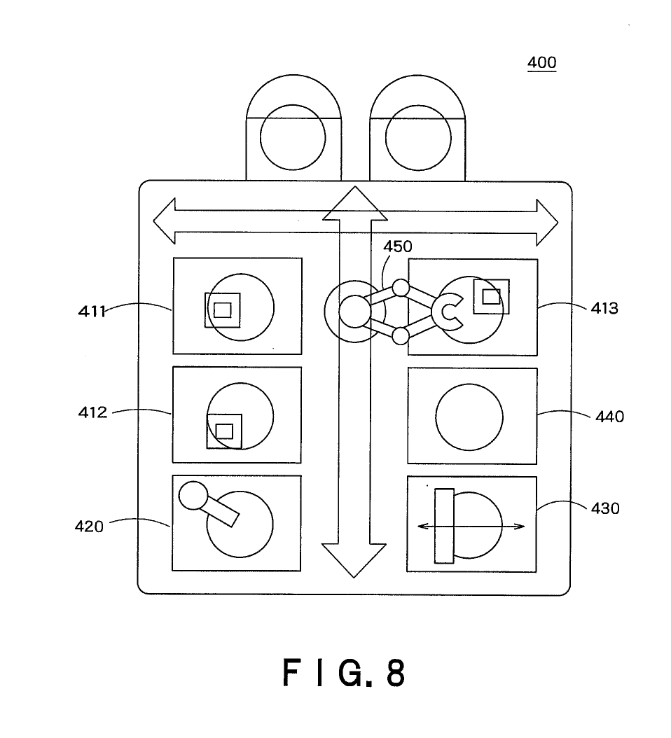

The method for forming the pattern according to the first embodiment can be executed by a pattern forming device 400 shown in FIG. 8. As shown in FIG. 8, the pattern forming device 400 includes imprint parts 411 to 413 to form the pattern by an imprint method, an applying part 420 to apply the inversion resin material 110, an irradiating part 430 to apply UV light such as vacuum UV rays (VUV), a heating part (baking process part) 440 to heat a wafer, and a conveying part 450 to convey the wafer from the part to part. Furthermore, the pattern forming device 400 includes a plasma etching part (not shown).

Specifically, the steps shown in FIGS. 1A to 1D are performed in the imprint parts 411 to 413. In addition, the UV irradiation shown in FIG. 2B is performed in the irradiating part 430, the curing process of the inversion resin material 110 shown in FIG. 2B is performed in the heating part 440, and the steps shown in FIGS. 2C and 2D are performed in the applying part 420. In addition, the steps shown in FIG. 2A, FIGS. 3A to 3C are performed in the plasma etching part.

While the three imprint parts 411 to 413 are provided in FIG. 8, just the one imprint part is enough.

In addition, when an ashing part to remove the resist is further provided in the pattern forming device 400, and the self-assembled material 310 is applied by the applying part 420, the method for forming the pattern according to the second embodiment can be executed.

Specifically, the steps shown in FIGS. 1A to 1D are performed in the imprint parts 411 to 413. In addition, the step shown in FIG. 6B is performed in the irradiating part 430, the steps shown FIGS. 6C and 6D are performed in the applying part 420, and the step shown in FIG. 7A is performed in the heating part 440. In addition, the steps shown in FIG. 6A and FIGS. 7B and 7C are performed in the plasma etching part, and the step shown in FIG. 7D is performed in the ashing part.

In addition, a contact angle indicator to automatically measure the contact angle between the surface of the mold pattern 104 (304) and the inversion resin material 110 (self-assembled material 310) may be provided in the pattern forming device 400.

In addition, while the mold pattern 104 (304) is formed by the imprint method using the template 103 in the first (second) embodiment, the mold pattern 104 (304) may be formed by the well-known photolithography.

In addition, the inversion resin material 110 (self-assembled material 310) is applied by the spin-coating in the first (second) embodiment, it may be applied by an ink-jet method. For example, when a density difference in the mold pattern 104 (304) is large because there is a large space part, the inversion resin material 110 (self-assembled material 310) is preferably applied with a discharge distribution adjusted by the ink-jet method based on a density distribution of the mold pattern 104 (304).

While the silicon-containing resist is used as the inversion resin material 110 in the first embodiment, SOG may be used. In addition, while the mixture solution of PS-PEO and SOG is used as the self-assembled material 310 in the second embodiment, another material may be used.

In addition, while UV-curing type SiO₂ material is used for the mold pattern 104 (304), and the liquid-repellent property on the surface is changed by the irradiation of the UV light in the above embodiments, a photosensitive resin may be used for the mold pattern 104 (304), and the liquid-repellent property may be changed by a plasma treatment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method for forming a pattern comprising:
forming a first pattern on a substrate;
irradiating an upper part of the first pattern with UV rays;
applying an inversion resin material to the substrate after the irradiation of the UV rays;
removing the first pattern after the application of the inversion resin material to form a second pattern containing the inversion resin material; and
processing the substrate using the second pattern as a mask.

2. The method for forming the pattern according to claim 1, wherein the first pattern is formed of a material capable of changing a contact angle with respect to the inversion resin material due to the irradiation of the UV rays.

3. The method for forming the pattern according to claim 1, wherein the inversion resin material is applied by an ink-jet method adjusted based on a density distribution of the first pattern.

4. The method for forming the pattern according to claim 1, wherein the first pattern is formed by an imprint process.

5. A method for forming a pattern comprising:
forming a first pattern on a substrate;
irradiating an upper part of the first pattern with UV rays;
applying a self-assembled material on the substrate after the irradiation of the UV rays;
heating the substrate after the application of the self-assembled material to align the self-assembled material to form a second pattern; and
processing the substrate using the first pattern and the second pattern as masks.

6. The method for forming the pattern according to claim 5, wherein the first pattern is formed of a material capable of changing a contact angle with respect to the self-assembled material due to the irradiation of the UV rays.

7. The method for forming the pattern according to claim 5, wherein a top part of the second pattern is removed before the substrate is processed.

8. The method for forming the pattern according to claim 5, wherein the self-assembled material is applied by an ink-jet method adjusted based on a density distribution of the first pattern.

9. The method for forming the pattern according to claim 5, wherein the first pattern is formed by an imprint process.

10. A pattern forming device comprising:
a forming part to form a first pattern on a substrate;
an irradiating part to irradiate an upper part of the first pattern with UV rays; and
an applying part to apply an inversion resin material or a self-assembled material to the substrate after the irradiation of the UV light by the irradiating part.

11. The pattern forming device according to claim 10, wherein the irradiating part applies UV rays having a VUV wavelength.

12. The pattern forming device according to claim 10, further comprising a heating part to heat the substrate having the self-assembled material applied by the applying part.

13. The pattern forming device according to claim 10, wherein the forming part forms the first pattern by an imprint method.
